(19) United States
(12) Patent Application Publication
(10) Pub. No.: US 2007/0136991 A1
(43) Pub. Date: Jun. 21, 2007

(54) BUFFER HINGE

(76) Inventor: Wen-Hsiu Huang, Chiayi City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/164,720

(22) Filed: Dec. 2, 2005

(51) Int. Cl. E05F 1/08

(52) U.S. Cl. 16/307

(57) ABSTRACT

The present invention relates to a buffer hinge. More particularly, the return spring is used to automatically open and close the door, and one end of the axis with a corresponding rotation is affixed with the buffer component with multiple convexes. The buffer component is positioned into the buffer container of the positioning component at one end of the positioning return spring. Moreover, the buffer container has multiple concaves for embedding the convexes of the buffer component. Therefore, when the angle for opening the door is larger, the return torque produced from the return spring has a greater increase. However, when the embedding number between the convexes and the concaves is relatively increased, the buffer resistance between the two is also larger. On the contrary, when the angle for closing the door is smaller, the return torque produced from the return spring has a smaller decrease. When the embedding number between the convexes and the concaves is relatively decreased, the buffer resistance between the two is also smaller. Therefore, the door does not act fast or slowly while opening and closing, and the impact between the door and the door socket will be minimized.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD OF THE INVENTION

Conventionally, a general hinge for automatically closing the door uses the spring torque of the hinge to achieve its action. However, while automatically closing the door, the door and the door socket will make a loud noise from the impact. Therefore, the buffer hinge is developed. The buffer hinge generally has three buffer methods to implement, which are:

The spring type buffer hinge not only has a return spring but also has a buffer spring. By a bounce reaction from the torque of the buffer spring, the impact during door closure can be lessened. However, since the door with an automatic return experiences fatigue phenomenon, the torque of the buffer spring is larger than the torque of the return spring thereto causes the door not to completely close.

The friction type buffer hinge uses the friction between two components to prevent a quick door return as well as achieving a buffer effect. Since damage to the door is produced from the friction, the friction surface becomes smooth and the material is changed. Therefore, the door loses the buffer effect after being in use for a period.

The oily type buffer hinge has equipment with a slow release of oil, and high density oily grease. Therefore, when the opened door is closing, the oil equipment is slowly releasing oil and prevents the density of the oil grease. More, the door can slowly be closed. However, this structure causes inefficiency from oil leakage. In other words, this equipment is not only complicated, but also has a higher cost.

According to the above descriptions, different buffer types have their advantages and disadvantages. However, they have a common problem, i.e. the buffer equipment should not have a large buffer resistance. Otherwise the door can not be closed completely. Moreover, when the angle for opening the door is smaller, the door can quickly and automatically return to be closed. It can certainly achieve a buffer effect. In other words, when the angle for opening the door is larger, the door during automatically returning to be closed causes a large inertia force. The inertia force always is largely far away from the buffer resistance. Therefore, the impact caused from the door and door socket makes the noise.

Furthermore, the above different types of the buffer equipment only can adjust at an adequate buffer force. Furthermore, the different angles for opening the door does not automatically adjust and produce an adequate buffer force.

### SUMMARY OF THE INVENTION

In order to solve the above mentioned problems, the buffer as mentioned in the above cannot automatically produce an adequate buffer force by the angle for opening the door. In the present invention, the two closed hinge flaps pivoted with an axis having a torque of the return spring can make one end of the axis be affixed with a buffer component that has multiple spring convexes. More, the buffer component is positioned in the corresponding buffer container. Therefore, the buffer container can have concaves for elastically embedding with the convexes of the buffer component. More, the axis can rotate following by the hinge flaps' swinging.

Furthermore, in two neighboring sides of the two hinge flaps, the neighboring side of one hinge flap has a brake component. The brake component produces a friction on the neighboring side of the other hinge flap.

According to the equipment of the present invention, when the angle for opening the door is larger, the return torque produced from the return spring is gradually increased. The embedding number between the convexes and the concaves is increased following the change of the angle. Therefore, the buffer resistance between the two is increased. Moreover, when the door closes gradually, the angle of the opened door is gradually decreased. The return torque produced from the return spring is gradually decreased. Further, the buffer resistance is gradually decreased. The force for automatically closing the door can automatically produce an adequate buffer force by the angle of the opened door. Therefore, the door does not act fast or slow while opening and closing, and the impact between the door and the door socket will be minimized.

The brake component between the two hinge flaps can produce a friction resistance, and can sufficiently secure the stabilization and the assistant buffer effect while the door is returning.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 shows a 3-D diagram of the present invention;

FIG. 2 is a cross-sectional view in the present invention;

FIG. 3 is a preferred embodiment of the present invention showing the function of the return spring;

FIG. 4 is a preferred embodiment of the present invention showing the buffer component while opening the door; and

FIG. 5 is a preferred embodiment of the present invention showing the buffer component while closing the door.

### DETAILED DESCRIPTION OF SOME EMBODIMENTS

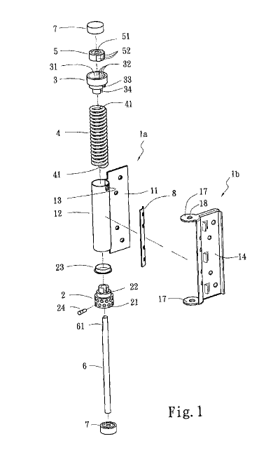

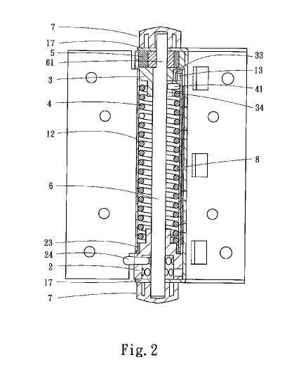

Please refer to FIG. 1 and FIG. 2. The buffer hinge in the present invention includes two hinge flaps (1a and 1b). One (1a) of the hinge flaps has a fixed portion (11) for affixing on the door socket, and a tube (12) for containing a return spring (4). The other (1b) of the hinge flaps has a fixed portion (14) for affixing on the door. More, the neighboring side corresponding to the tube (12) of the hinge flap (1a) has a brake component (8). The upper and the lower of the hinge flap (1b) have the pivoted portions (17). The upper (and the lower) of the pivoted portion (17) has an (the) embedded hole(s) (18).

Further, the upper of the tube (12) in the hinge flap (1a) has a positioning component (3). The stop portion (13) of the tube (12) is embedded into the embedded container (33) of the positioning component (3), and the positioning component (3) therefore cannot rotate. More, the hook (41) in the upper of the return spring (4) is embedded into the embedded spring container (34) of the positioning component (3). Besides, the top of the positioning component (3) has a buffer container (31). The buffer container (31) has a buffer component with multiple elastic concaves (32). More, the buffer container (31) has a buffer component (5) with multiple elastic convexes (52). Therefore, the convexes (52) can be elastically embedded into the concaves (32).

The lower of the tube (12) in the hinge flap (1a) pre-has a ring (23). Further, an adjusted component (2) is positioned into the tube (12), and the hook (41) in the lower of the return spring (4) is embedded into the embedded spring container (22) of the adjusted component (2). In the same time, the peripheral side of the adjusted component (2) has multiple hoes (21) for inserting the bump component (24).

The upper and lower of the pivoted portion (17) are positioned in the outside of the positioning component (3) and the adjusted component (2). Another axis (6) is pivoted with the two hinge flaps (1a and 1b) and the middle of the adjusted component (2) and the positioning component (3). Therefore, the fixed portion of the axis (61) in one end of the axis (6) is positioned into the fixed hole (51) of the buffer component (5) and the embedded hole (18) of the hinge flap (1b). Later, both ends of the axis (6) are embedded into the cover component of the axis end (7).

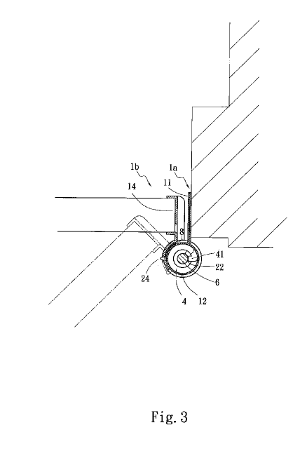

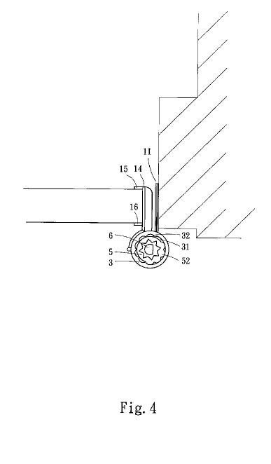

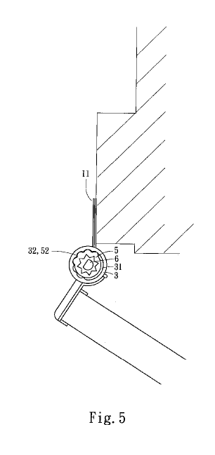

Please refer to FIG. 3, when the adjusted component (2) is rotated and the return spring (4) produces a return torque, the bump component (24) is just leant on the edge of the hinge flap (1b). More, the two hinge flaps (1a and 1b), therefore, can be at a close status. While the angle for opening the door is larger, the return torque produced from the return spring (4) is gradually increased. Therefore, the door can automatically return to be closed. Please refer to FIG. 4 and FIG. 5. When the door is at a close status, the convexes (52) of the buffer component (5) are not embedded into the concaves (32) of the buffer container (31). However, when the door is gradually opened, the fixed portion (14) of the door is actuated to be rotated. Further, the embedded hole (18) of the fixed portion (14) actuates the axis (6) and the buffer component (5) to be rotated. Therefore, the convexes (52) are embedded into the concaves (32). When the angle for opening the door is larger, the embedding number between the convexes (52) and the concaves (32) has more, and the parting resistance between these two is larger.

When releasing the door, the door is automatically closed by the return torque of the return spring (4). In the meantime, the axis (6) also can actuate the buffer component (5) to be reversed. Further, the convexes (52) of the buffer component (5) are reversed. Another concave (32) is appeared instead of the previous concave (32). Therefore, the embedding number between the convexes (52) and the concaves (32) is gradually decreased. In other words, when the angle for opening the door is lager, the embedding number between the convexes (52) and the concaves (32) is larger. More, the buffer resistance is also larger. When the angle for closing the door is smaller, the embedding number between the convexes (52) and the concaves (32) is decreased. More, the buffer resistance is also smaller.

In sum, when the angle for opening the door is larger, the return torque produced from the return spring (4) is also gradually increased. The buffer resistance is also increased. On the contrary, when the angle for closing the door is smaller, the return torque produced form the return spring (4) is gradually decreased. The buffer resistance is also smaller. Therefore, the buffer hinge can automatically produce an adequate buffer force. Furthermore, the door does not act fast or slow while opening and closing, and the impact between the door and the door socket will be minimized.

The brake component (8) between the two hinge flaps (1a and 1b) can produce a friction resistance during door closing, and can much secure the stabilization and the buffer effect while door closing for the hinge.

What is claimed is:

1. A buffer hinge comprising:
two hinged flaps pivoted with the axis for a elastic close; and
the axis rotated by following hinge flaps' swinging;
wherein one end of the axis affixed with a buffer component having multiple convexes;
wherein the buffer component positioned in the buffer container of the corresponding hinge flaps; and wherein the buffer container having multiple concaves for elastically embedding or removing the convexes of the buffer component.

2. A buffer hinge as cited in claim 1, wherein the convex of the buffer component is made of an elastic material.

3. A buffer hinge as cited in claim 1, wherein one hinge flap has a return spring;
said one end of the return spring is affixed on the non-rotational positioning component of the hinge flap; said the other end of the return spring is affixed on the rotational adjusted component; said the axis is pivoted with the positioning component and the adjusted component; said a pair of bumps in the other hinge flap is positioned on the adjusted component; and said one end of the axis is embedded into the hinge flap.

4. A buffer hinge as cited in claim 1, wherein the two pivoted axis of the flaps have two neighboring sides; said the neighboring side of one hinge flap has a brake component; and said the brake component can produce a brake resistance on the neighboring side of the other hinge.
